(19) United States
(12) Patent Application Publication
(10) Pub. No.: US 2011/0135981 A1
(43) Pub. Date: Jun. 9, 2011

(54) NONAQUEOUS ELECTROLYTE SECONDARY BATTERY AND METHOD FOR FABRICATING THE SAME

(76) Inventors: Toshitada Sato, Osaka (JP); Yasutaka Kogetsu, Osaka (JP)

(21) Appl. No.: 13/058,111

(22) PCT Filed: Aug. 5, 2010
(86) PCT No.: PCT/JP2010/004939

§ 371 Date: Feb. 8, 2011

(30) Foreign Application Priority Data
Aug. 7, 2009 (JP) 2009-184130

(51) Int. Cl. H01M 4/13; H01M 4/70; H01M 10/36; H01M 10/052; H01M 10/04

(52) U.S. Cl. 429/94; 429/233; 429/218.1; 29/623.1; 29/623.5

(57) ABSTRACT

A negative electrode of a nonaqueous electrolyte secondary battery includes a negative electrode current collector (21A) and a negative electrode active material layer (21B). The negative electrode current collector (21A) has a thickness of greater than or equal to 20 μm and less than or equal to 50 μm. The negative electrode active material layer (21B) is provided on at least one surface of the negative electrode current collector (21A). The negative electrode is formed by cutting a negative electrode original sheet to a predetermined width. The negative electrode has cutting roll over portions (21D) at cut ends thereof. The cutting roll over portions (21D) are formed by stretching the negative electrode current collector (21A) upwardly or downwardly in the thickness direction of the negative electrode, and are oriented toward an inner side of an electrode group (31).

### TECHNICAL FIELD

The present invention relates to nonaqueous electrolyte secondary batteries and methods for fabricating the same.

### BACKGROUND ART

In recent years, there have been demands for use of secondary batteries in vehicles in view of environmental protection, and also demands for use of DC power sources for large-size tools. To satisfy such demands, small-size and lightweight secondary batteries which can be charged quickly and can discharge a high current are required. Examples of secondary batteries satisfying such demands include nonaqueous electrolyte secondary batteries (hereinafter also simply referred to as a “battery”). In general, such a nonaqueous electrolyte secondary battery has the following structure.

A nonaqueous electrolyte secondary battery includes an electrode group and an electrolyte which are placed in a battery case made of metal. The electrode group includes a positive electrode, a negative electrode, and a porous insulating layer. The positive electrode includes a positive electrode current collector, and a positive electrode active material provided on a surface of the positive electrode current collector. The negative electrode includes a negative electrode current collector, and a negative electrode active material provided on a surface of the negative electrode current collector. The porous insulating layer is provided between the positive electrode and the negative electrode to prevent short-circuiting between the positive electrode and the negative electrode. The positive electrode active material electrochemically reacts reversibly with lithium ions, and is, for example, lithium cobalt composite oxide. The negative electrode active material is capable of inserting and extracting lithium ions, and is, for example, carbon. The electrolyte is an aprotic organic solvent in which lithium salt (e.g., LiClO₄ or LiPF₆) is dissolved. Note that a battery case made of aluminum laminate film may be used instead of the battery case made of metal.

It has been requested to increase the capacity of such a nonaqueous electrolyte secondary battery. As a method for increasing the capacity of the battery, the method of densely providing an active material on a surface of a current collector, or the method of using, as a negative electrode active material, a material (silicon, a silicon compound, tin, or a tin compound) capable of inserting more lithium compared to graphite has been proposed. However, when the capacity of the battery is increased, the negative electrode active material largely expands and contracts due to charge/discharge, which significantly deforms the negative electrode. Thus, problems such as deformation of the electrode group are more likely to occur. To solve the problems, it has been proposed, for example, to increase the thickness of the negative electrode current collector, or to increase the strength of the negative electrode current collector (PATENT DOCUMENT 1).

### Citation List

### Patent Document

PATENT DOCUMENT 1: Japanese Patent Publication No. 2003-7305

### SUMMARY OF THE INVENTION

### Technical Problem

It was found that an internal short-circuit may occur when the thickness of the negative electrode current collector is increased.

The present invention was devised in consideration of the problems discussed above. It is an object of the present invention to provide a nonaqueous electrolyte secondary battery in which an internal short-circuit is less likely to occur.

### Solution to the Problem

A nonaqueous electrolyte secondary battery of the present invention includes an electrode group including a positive electrode, a negative electrode, and a porous insulating layer. The negative electrode includes a negative electrode current collector and a negative electrode active material layer. The negative electrode current collector has a thickness of greater than or equal to 20 μm and less than or equal to 50 μm. The negative electrode active material layer is provided on at least one surface of the negative electrode current collector. The negative electrode is formed by cutting a negative electrode original sheet to a predetermined width. The negative electrode has a cutting roll over portion at a cut end thereof. The cutting roll over portion is formed by stretching the negative electrode current collector upwardly or downwardly in the thickness direction of the negative electrode. The cutting roll over portion is oriented toward an inner side of the electrode group.

When the nonaqueous electrolyte secondary battery as described above is charged, the negative electrode deforms toward the inner side of the electrode group. Thus, it is possible to prevent the porous insulating layer from being crushed due to the deformation of the negative electrode.

Note that in the present specification, the “negative electrode active material layer” includes, when the negative electrode active material is a carbon material, the negative electrode active material and a binder, whereas when the negative electrode active material is silicon, tin, or a compound of silicon or tin, the “negative electrode active material layer” is made of the negative electrode active material.

When the electrode group is formed by winding the positive electrode and the negative electrode with a porous insulating layer interposed therebetween, the cutting roll over portion is oriented toward an inner side in the radial direction of the electrode group. When the electrode group is formed by stacking the positive electrode and the negative electrode with a porous insulating layer interposed therebetween, the cutting roll over portion is oriented toward an inner side in the thickness direction of the electrode group.

The width of the negative electrode is preferably larger than that of the positive electrode. With this configuration, ends in the width direction of the positive electrode are located, in the width direction, inside ends in the width direction of the negative electrode. Thus, it is possible to prevent reduction in battery capacity. Moreover, the ends in the width direction of the negative electrode can be prevented from penetrating the porous insulating layer to come into contact with the positive electrode.

The negative electrode active material is preferably silicon, a silicon compound, tin, or a tin compound.

The cutting roll over portion may be formed by stretching only the negative electrode current collector, or may be formed by stretching the negative electrode current collector and the negative electrode active material layer.

In a method for fabricating a nonaqueous electrolyte secondary battery of the present invention, a negative electrode original sheet is first prepared. The negative electrode original sheet includes a negative electrode current collector and a negative electrode active material layer provided on at least one surface of the negative electrode current collector, the negative electrode active material layer containing a negative electrode active material. Next, the negative electrode original sheet is cut to a predetermined width to form a plurality of negative electrodes. Subsequently, a porous insulating layer is disposed between a positive electrode and one of the negative electrodes to form an electrode group. The thickness of the negative electrode current collector is greater than or equal to 20 μm and less than or equal to 50 μm. In the process of forming the negative electrodes, cutting roll over portions are formed at cut ends of each of the negative electrodes. The cutting roll over portions are formed by stretching the negative electrode current collector upwardly or downwardly in the thickness direction of the negative electrode. The cutting roll over portions formed at both the ends in the width direction of each negative electrode are oriented in a same direction, whereas the cutting roll over portions formed at the cut ends adjacent to each other are oriented in opposite directions. In the process of forming the electrode group, the electrode group is formed so that the cutting roll over portions are oriented toward an inner side of the electrode group.

In the method for fabricating a nonaqueous electrolyte secondary battery of the present invention, the positive electrode and the negative electrode may be wound with the porous insulating layer interposed therebetween so that the cutting roll over portions are oriented toward an inner side in the radial direction of the electrode group.

### Advantages of the Invention

According to the present invention, it is possible to reduce internal short-circuits.

### BRIEF DESCRIPTION OF THE DRAWINGS

FIG. 1 is a photomicrograph of a negative electrode formed by cutting a negative electrode original sheet.

FIGS. 2A and 2B are sectional views illustrating process steps of a method for forming a negative electrode in a sequential order.

FIGS. 3A and 3B are sectional views illustrating process steps of a method for forming another negative electrode in a sequential order.

FIGS. 4A and 4B are sectional views illustrating process steps of a method for forming yet another negative electrode in a sequential order.

FIG. 5 is an exploded perspective view of a nonaqueous electrolyte secondary battery according to an embodiment of the present invention.

FIG. 6 is a sectional view illustrating an electrode group of the embodiment of the present invention.

FIG. 7 is a sectional view of the nonaqueous electrolyte secondary battery according to the embodiment of the present invention.

FIGS. 8A and 8B are sectional views illustrating some process steps of a method for forming an electrode group of an embodiment of the present invention in a sequential order.

FIGS. 9A and 9B are sectional views illustrating process steps of another method for forming an electrode group of an embodiment of the present invention in a sequential order.

FIG. 10 is a sectional view of a nonaqueous electrolyte secondary battery of a variation of the embodiment of the present invention.

FIG. 11 is a sectional view of a nonaqueous electrolyte secondary battery of another variation of the embodiment of the present invention.

FIG. 12 is a table showing results of the first example.

FIG. 13 is a table showing results of the second example.

### DESCRIPTION OF EMBODIMENTS

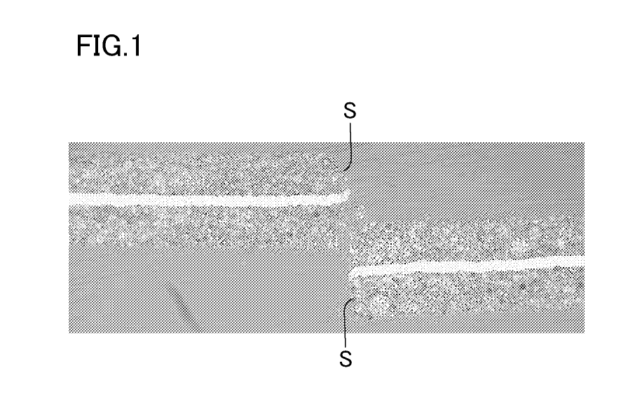

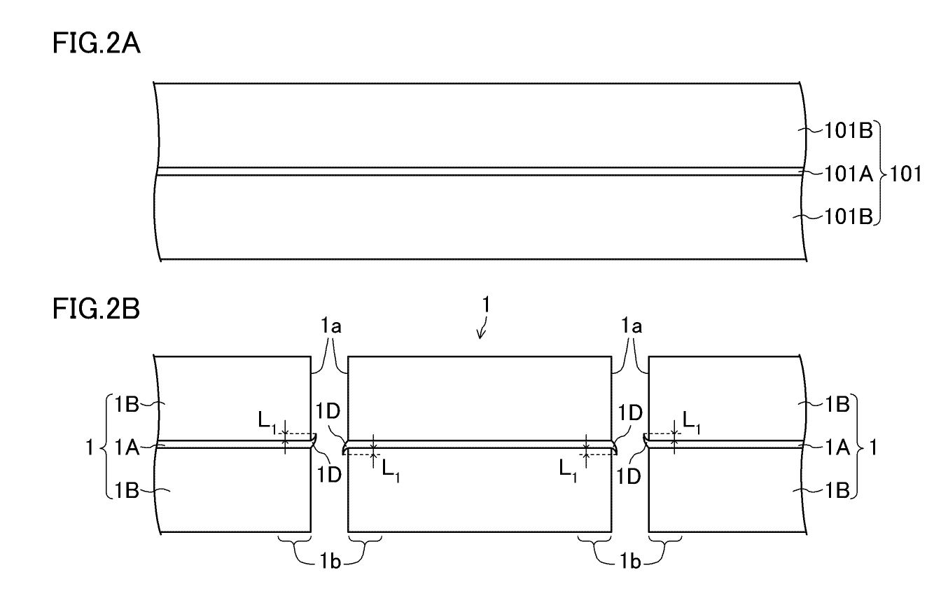

Prior to description of embodiments of the present invention, the logic that the present invention was accomplished will be described. FIG. 1 is a photomicrograph of a negative electrode formed by cutting a negative electrode original sheet. FIGS. 2A and 2B are sectional views illustrating process steps of a method for fabricating the negative electrode in a sequential order.

A positive electrode and a negative electrode of a nonaqueous electrolyte secondary battery are formed by cutting a positive electrode original sheet and a negative electrode original sheet, respectively, to a predetermined width. As a positive electrode current collector, for example, aluminum is used, and as a positive electrode active material, a compound oxide mainly of lithium and a transition metal is used. In many cases, the compound oxide of lithium and a transition metal is very hard. Therefore, when the positive electrode original sheet is cut, the positive electrode active material grinds a cutting blade. Thus, in many cases, a cut surface of the positive electrode results in a flat surface with few raised and recessed portions. On the other hand, as a negative electrode current collector, copper or nickel is used, and as a negative electrode active material, a carbon material such as graphite or a compound containing silicon or tin is used. Since the negative electrode active material is softer than the positive electrode active material, the negative electrode or the negative electrode current collector is stretched by the cutting blade (hereinafter simply referred to as “stretching effect by the cutting blade occurs”) when the negative electrode original sheet is cut, as a result of which cutting roll over portions may be formed. The cutting roll over portions are formed in such a manner that the negative electrode current collector, or the negative electrode current collector and negative electrode active material layers are stretched upwardly or downwardly in the thickness direction of the negative electrode at cut ends S of the negative electrode when the negative electrode original sheet is cut.

For example, a negative electrode original sheet 101 illustrated in FIG. 2A is cut to a predetermined width, where a negative electrode current collector 101A is copper foil having a thickness of less than 10 μm (e.g., 8 μm), and negative electrode active material layers 101B include graphite as the negative electrode active material. Then, as illustrated in FIG. 2B, a negative electrode 1 including negative electrode active material layers 1B on both surfaces of a negative electrode current collector 1A is formed. Here, cutting roll over portions 1D are formed at cut ends 1b. The cutting roll over portions 1D are formed by stretching the negative electrode current collector 1A upwardly or downwardly in the thickness direction of the negative electrode 1 from cut end faces 1a. The length L₁ of the cutting roll over portions 1D (in the specification, the length of the cutting roll over portion is the shortest distance from the tip of the cutting roll over portion to the negative electrode current collector) is not very long, and is less than 10 μm. Therefore, it can be considered that there is an extremely low possibility that the cutting roll over portions 1D penetrate a porous insulating layer (not shown) and come into contact with a positive electrode (not shown). Thus, in this case, even if a nonaqueous electrolyte secondary battery is fabricated with the existence of the cutting roll over portions 1D being ignored, the safety of the nonaqueous electrolyte secondary battery can be less susceptible to degradation.

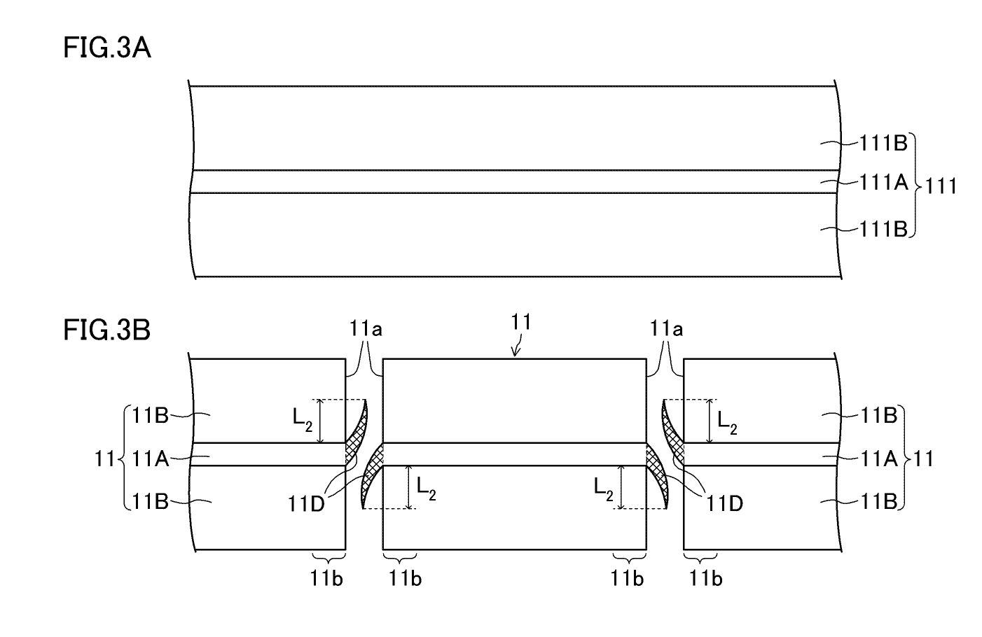

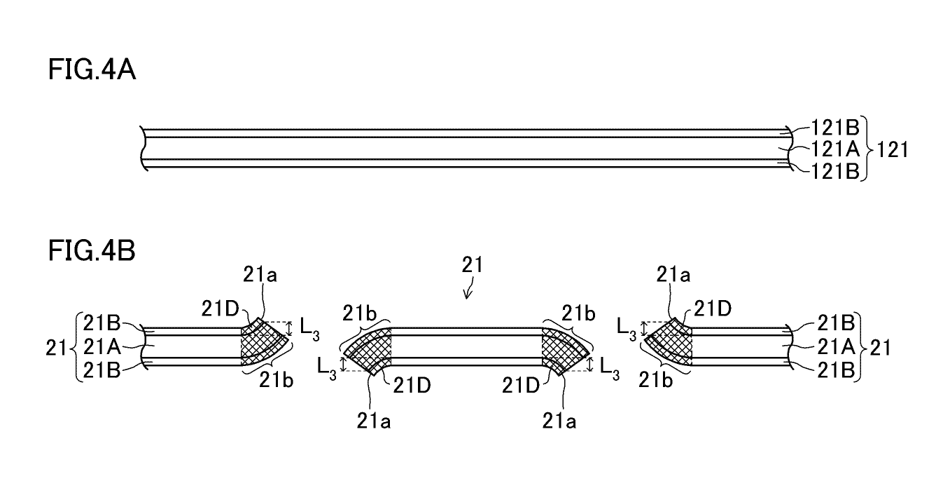

Incidentally, it is requested, these days, to increase the capacity of nonaqueous electrolyte secondary batteries. When the capacity is increased, the expansion rate of negative electrode active materials during charge increases, so that negative electrodes are significantly deformed. For this reason, it has been proposed that the thickness of negative electrode current collectors is increased to ensure the strength of the negative electrodes. Then, the inventors of the present application formed two negative electrodes described below by way of experiment. FIGS. 3A and 3B are sectional views of process steps of a method for fabricating a first negative electrode in a sequential order. FIGS. 4A and 4B are sectional views of process steps of a method for fabricating a second negative electrode in a sequential order.

A first negative electrode 11 was formed by cutting a negative electrode original sheet 111 illustrated in FIG. 3A to a predetermined width. The thickness of a negative electrode current collector 111A was about 30 μm, and negative electrode active material layers 111B were densely filled with graphite. When the negative electrode original sheet 111 was cut to a predetermined width, a negative electrode current collector 11A was stretched upwardly or downwardly in the thickness direction of the negative electrode 11 from cut end faces 11a (negative electrode active material layers 11B were not stretched), thereby forming cutting roll over portions 11D (cross-hatched portions illustrated in FIG. 3B) at cut ends 11b of the negative electrode 11. Then, the length L₂ of the cutting roll over portions 11D was larger than the length L₁ in FIG. 2B, and was equal to or longer than 30 μm. The reason why the length L₂ was thus larger than the length L₁ in FIG. 2B is probably as follows. That is, the negative electrode active material layers 111B are densely filled with graphite, and the thickness of the negative electrode current collector 111A is larger than that of the negative electrode current collector 101A of the negative electrode original sheet 101, so that the stretching effect by a cutting blade easily occurs.

A second negative electrode 21 was formed by cutting a negative electrode original sheet 121 illustrated in FIG. 4A to a predetermined width. The thickness of a negative electrode current collector 121A was about 30 μm, and negative electrode active material layers 121B were formed by evaporating silicon, tin, or a compound of silicon or tin on both surfaces of the negative electrode current collector 121A. When the negative electrode original sheet 121 was cut to a predetermined width, the negative electrode 21 is stretched upwardly or downwardly in the thickness direction at cut ends 21b, thereby forming cutting roll over portions 21D (cross-hatched portions in FIG. 4B). Two reasons why not only a negative electrode current collector 21A but also a negative electrode active material layers 21B were thus stretched are probably as follows. The first reason is that the negative electrode original sheet 121 includes the negative electrode active material evaporated on the surfaces of the negative electrode current collector 121A, and thus the adhesive strength between the negative electrode current collector 121A and the negative electrode active material layers 121B of the negative electrode original sheet 121 is larger than that between the negative electrode current collector 111A and the negative electrode active material layers 111B of the negative electrode original sheet 111, so that the stretching effect by a cutting blade easily occurs. The second reason is that the thickness of the negative electrode active material layers 121B is smaller than that of the negative electrode active material layers 111B of the negative electrode original sheet 111. The length L₃ of the cutting roll over portions 21D was larger than that of the length L₁ in FIG. 2B, and was equal to or larger than 30 μm. The reason for this is probably that the thickness of the negative electrode current collector 121A is larger than that of the negative electrode current collector 101A in FIG. 2.

When nonaqueous electrolyte secondary batteries were fabricated by using the thus formed two kinds of negative electrodes 11, 21, internal short-circuits occurred in some of the nonaqueous electrolyte secondary batteries during charge. The batteries in which internal short-circuits occurred were disassembled to identify a cause of the occurrence of the internal short-circuit. As a result, it was found that the cutting roll over portions in all the batteries in which internal short-circuits occurred were oriented toward the outer side of the electrode group. Based on this finding and on that the cutting roll over portions at both ends in the width direction of each of the negative electrodes are oriented in the same direction (e.g., upwardly in the thickness direction of each negative electrode) (FIGS. 3B and 4B)), the present inventors accomplished the present invention.

Here, to cut a negative electrode original sheet, a Goebel method and a gang method are known. In case of the Goebel method, a negative electrode original sheet is passed between two round blades whose outer circumferences slightly overlap with each other, thereby being sheared. In case of the gang method, a negative electrode original sheet is passed between an upper blade and a lower blade to be cut by being pressed.

Embodiments of the present invention will be described below with reference to the drawings. Note that the present invention is not limited to the embodiments below.

### First Embodiment

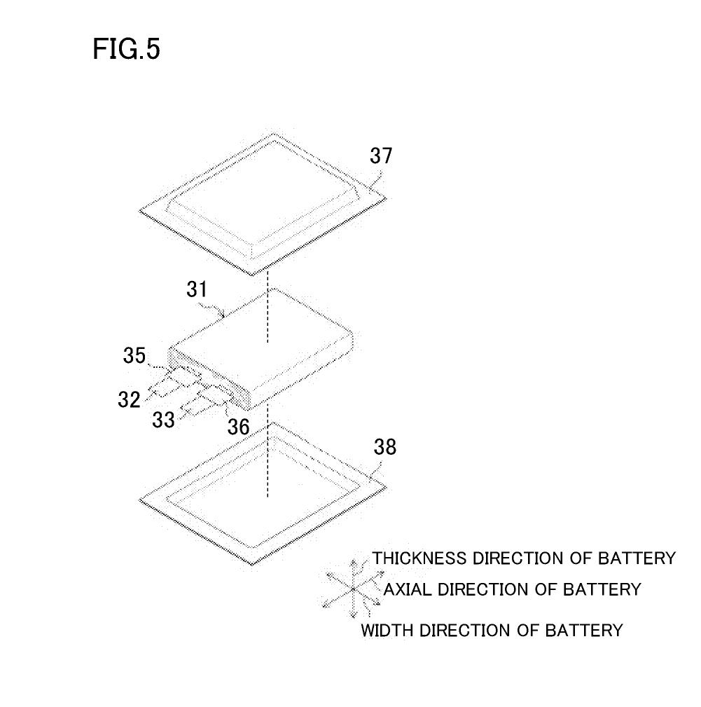

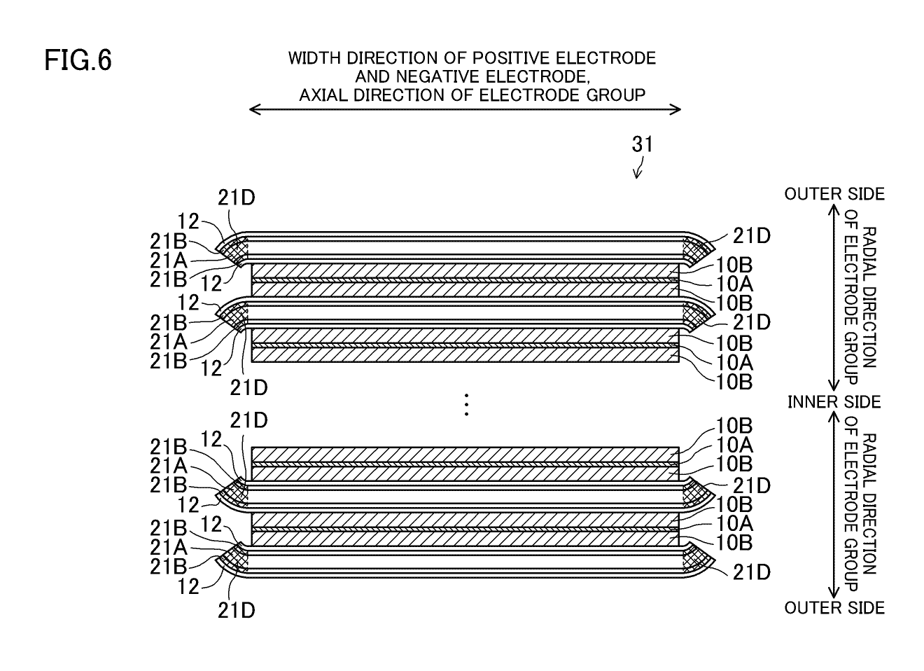

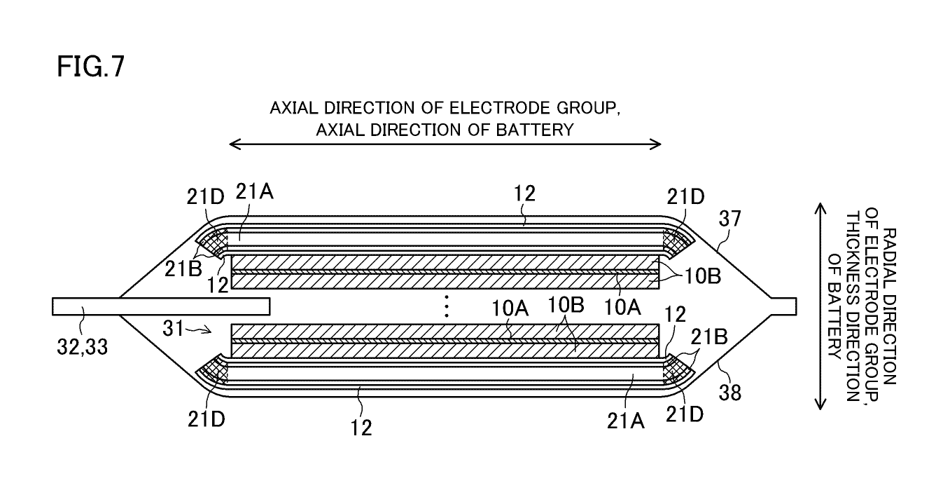

First, a configuration of a nonaqueous electrolyte secondary battery according to a first embodiment of the present invention will briefly be described. FIG. 5 is an exploded perspective view of the nonaqueous electrolyte secondary battery according to the present embodiment. FIG. 6 is a sectional view of an electrode group of the present embodiment. FIG. 7 is a sectional view of the nonaqueous electrolyte secondary battery according to the present embodiment.

As illustrated in FIG. 5, the nonaqueous electrolyte secondary battery according to the present embodiment includes a flat electrode group 31 placed in a battery case made of laminate film 37 and 38. A positive electrode lead 32 made of aluminum and a negative electrode lead 33 made of nickel extend from one end face of the electrode group 31. The positive electrode lead 32 is heat-welded to the battery case with a tape 35 interposed therebetween. The negative electrode lead 33 is heat-welded to the battery case with a tape 36 interposed therebetween.

The electrode group 31 includes a positive electrode 10 and a negative electrode 21 wound with a porous insulating layer 12 interposed therebetween. As illustrated in FIGS. 6 and 7, the width of the negative electrode 21 is preferably larger than that of the positive electrode 10. When the width of the negative electrode 21 is larger than that of the positive electrode 10, the electrode group 31 can be formed without shifting the positive electrode 10 and the negative electrode 21 relative to each other in the width direction. Since the electrode group 31 includes the positive electrode 10 facing the negative electrode 21, reduction in battery capacity can be limited to a lesser extent. Moreover, since ends in the width direction of the negative electrode 21 are located outside ends in the width direction of the positive electrode 10, tips of cutting roll over portions 21D are prevented from penetrating the porous insulating layer 12 to come into contact with the positive electrode 10, thereby preventing internal short-circuits.

The positive electrode 10 includes a positive electrode current collector 10A, and positive electrode mixture layers 10B. The positive electrode current collector 10A is, for example, aluminum foil. The positive electrode mixture layers 10B are provided on surfaces of the positive electrode current collector 10A, and include a positive electrode active material (e.g., lithium compound oxide), a binder, and a conductive agent.

The negative electrode 21 includes a negative electrode current collector 21A, and negative electrode active material layers 21B. The negative electrode current collector 21A is, for example, copper foil. The thickness of the negative electrode current collector 21A is greater than or equal to 20 μm and less than or equal to 50 μm, and is preferably greater than or equal to 30 μm. The negative electrode active material layers 21B are provided on surfaces of the negative electrode current collector 21A, are made of a negative electrode active material (silicon, tin, a silicon compound, or a tin compound), and each have a thickness of several micrometers to 30 μm in a charged state. The negative electrode active material of the present embodiment is capable of inserting more lithium ions compared to graphite, so that the capacity of the battery can be increased. As the capacity is increased, the expansion rate of the negative electrode active material increases, but the thickness of the negative electrode current collector 21A is greater than or equal to 20 μm, so that the strength of the negative electrode 21 can be ensured. Note that the thickness of the negative electrode current collector 21A is less than or equal to 50 μm, and thus the negative electrode 21 can easily be wound to form the electrode group 31.

The negative electrode 21 as described above is formed by cutting a negative electrode original sheet 121 illustrated in FIG. 4A to a predetermined width. Therefore, the negative electrode 21 includes the cutting roll over portions 21D at the ends (cut ends 21b) in the width direction (lateral direction) thereof. The cutting roll over portions 21D are formed by stretching the negative electrode 21 (i.e., the negative electrode current collector 21A and the negative electrode active material layers 21B) at the cut ends 21b upwardly or downwardly in the thickness direction. Therefore, in the thickness direction of the negative electrode 21, cut end faces 21a of the negative electrode 21 are located above or below a center portion in the width direction of the negative electrode 21. The cut end faces 21a are inclined relative to the thickness direction of the negative electrode 21. The length L₃ of the cutting roll over portions 21D is greater than or equal to 30 μm. The larger the thickness of the negative electrode current collector 21A is, the larger the length L₃ is. The cutting roll over portions 21D as described above are oriented toward the inner side in the radial direction of the electrode group 31 as illustrated in FIG. 6, and extend along an inner circumferential surface of the battery case as illustrated in FIG. 7.

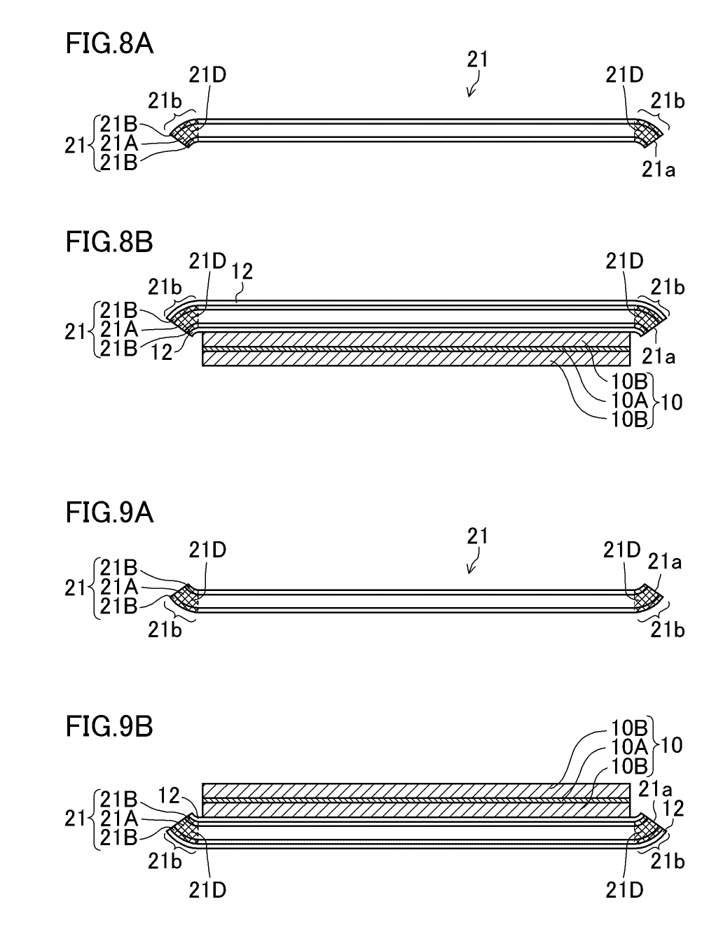

In order to further describe the cutting roll over portions 21D of the present embodiment, a method for forming the electrode group 31 of the present embodiment will be described with reference to FIGS. 4A, 4B, and 8A-9B. FIGS. 8A and 8B are sectional views illustrating some process steps of a method for forming the electrode group 31 of the present embodiment in a sequential order. FIGS. 9A and 9B are sectional views illustrating some process steps of another method for forming the electrode group 31 of the present embodiment in a sequential order.

First, copper foil having a thickness of greater than or equal to 20 μm and less than or equal to 50 μm is prepared as a negative electrode current collector 121A. Silicon, tin, or a compound of silicon or tin is evaporated on both surfaces of the negative electrode current collector 121A. In this way, a negative electrode original sheet 121 illustrated in FIG. 4A is formed (step (a)).

Next, as illustrated in FIG. 4B, the negative electrode original sheet 121 is cut to a predetermined width (step (b)).

When the negative electrode original sheet 121 is cut, cutting roll over portions 21D are formed at cut ends 21b. When attention is directed toward each of negative electrodes 21, the cutting roll over portions 21D are oriented in the same direction in the thickness direction of the negative electrode 21. Specifically, both the cutting roll over portions 21D of the negative electrode 21 located at the center in FIG. 4B are oriented downwardly in the thickness direction of the negative electrode 21.

In contrast, when attention is directed toward the cut ends 21b adjacent to each other, the cutting roll over portions 21D are oriented in opposite directions in the thickness direction of the negative electrodes 21. For example, at the cut end 21b of the negative electrode 21 located on the left in FIG. 4B, the negative electrode 21 is deformed in a raised manner, whereas at the cut end 21b of the negative electrode 21 located at the center in FIG. 4B, the negative electrode 21 is deformed in a falling manner. That is, the formed negative electrodes 21 include a negative electrode 21 whose cutting roll over portions 21D are oriented downwardly in the thickness direction as illustrated in FIG. 8A, and a negative electrode 21 whose cutting roll over portions 21D are oriented upwardly in the thickness direction as illustrated in FIG. 9A.

In the case of the negative electrode 21 illustrated in FIG. 8A, porous insulating layers 12 are provided on an upper surface and a lower surface of the negative electrode 21 as illustrated in FIG. 8B, and then a positive electrode 10 is disposed on the porous insulating layer 12 provided on the lower surface of the negative electrode 21. That is, the positive electrode 10 is disposed on the same side as cut end faces 21a relative to the negative electrode 21. Then, the positive electrode 10, the porous insulating layers 12, and the negative electrode 21 are wound so that the negative electrode 21 is located radially outside the positive electrode 10 (step (c)). In this way, as illustrated in FIG. 6, the electrode group 31 is formed so that the cutting roll over portions 21D are oriented toward the inner side in the radial direction.

In the case of the negative electrode 21 illustrated in FIG. 9A, porous insulating layers 12 are provided on an upper surface and a lower surface of the negative electrode 21 as illustrated in FIG. 9B, and then a positive electrode 10 is disposed on the porous insulating layer 12 provided on the upper surface of the negative electrode 21. That is, the positive electrode 10 is disposed on the same side as cut end faces 21a relative to the negative electrode 21. Then, the positive electrode 10, the porous insulating layers 12, and the negative electrode 21 are wound so that the negative electrode 21 is located radially outside the positive electrode 10 (step (c)). In this way, as illustrated in FIG. 6, the electrode group 31 is formed so that the cutting roll over portions 21D are oriented toward the inner side in the radial direction.

The relationship between the orientation of the cutting roll over portions 21D and the occurrence of an internal short-circuit in the electrode group 31 will be described below.

When a nonaqueous electrolyte secondary battery is charged, a negative electrode active material expands, thereby deforming a negative electrode. When an electrode group is formed so that cutting roll over portions are oriented toward the outer side in the radial direction, stress due to the expansion of the negative electrode active material occurs outwardly in the radial direction of the electrode group. However, there is not much space radially outside the electrode group (between an outer circumferential surface of the electrode group and an inner circumferential surface of a battery case). Therefore, the negative electrode cannot satisfactorily be deformed outwardly in the radial direction of the electrode group, and deforms, thereby crushing a porous insulating layer. This causes an internal short-circuit.

In contrast, in the electrode group 31 of the present embodiment, the stress occurs inwardly in the radial direction of the electrode group 31. Space in which a winding rod (a rod around which a positive electrode and a negative electrode are wound when an electrode group is formed) was provided exists radially inside the electrode group 31. Therefore, the negative electrode 21 can satisfactorily be deformed inwardly in the radial direction of the electrode group 31, so that the negative electrode 21 can be deformed without crushing the porous insulating layer 12. Thus, it is possible to reduce internal short-circuits.

Moreover, the cutting roll over portions 21D of the nonaqueous electrolyte secondary battery according to the present embodiment extend along an inner circumferential surface of the battery case. Thus, even if force is applied from outside the battery case, it is possible to prevent the cutting roll over portions 21D from sticking in the battery case.

In sum, the negative electrode active material of the present embodiment is silicon, tin, a silicon compound, or tin compound, and the thickness of the negative electrode current collector 21A of the present embodiment is greater than or equal to 20 μm and less than or equal to 50 μm. Thus, it is possible to provide a high-capacity battery, and to reduce deformation of the negative electrode 21 during charge. Moreover, the cutting roll over portions 21D are oriented toward the inner side in the radial direction of the electrode group 31. Thus, it is possible to reduce internal short-circuits when the nonaqueous electrolyte secondary battery according to the present embodiment is charged. In this way, in the present embodiment, it is possible to provide a high-capacity battery whose safety during charge is ensured.

Examples of the positive electrode 10, the porous insulating layers 12, and the electrolyte of the present embodiment are sequentially described below. Note that specific examples below apply to first and second variations which will be described later.

—Positive Electrode 10—

Examples of materials included in the positive electrode 10 are listed below.

The positive electrode current collector 10A may have a plurality of pores formed therein. The thickness of the positive electrode current collector 10A is preferably greater than or equal to 1 μm and less than or equal to 500 μm, and is more preferably greater than or equal to 10 μm and less than or equal to 20 μm. With this configuration, it is possible to reduce the weight of the positive electrode 10 with the strength of the positive electrode 10 being maintained.

The positive electrode active material may be, for example, a lithium compound oxide such as LiCoO₂, LiNiO₂, or LiMnO₂, or may be a lithium compound oxide after, for example, a hydrophobization process. The average particle size of the positive electrode active material may be greater than or equal to 5 μm and less than or equal to 20 μm. When the average particle size of the positive electrode active material is less than 5 μm, the surface area of the positive electrode active material increases, thereby increasing the amount of the binder, which may reduce the battery capacity. In contrast, when the average particle size of the positive electrode active material is greater than 20 μm, coating streaks may appear when a positive electrode mixture slurry is applied on the surfaces of the positive electrode current collector.

The binder may be, for example, poly vinylidene fluoride (PVDF), polytetrafluoroethylene, polyethylene, polypropylene, or an aramid resin. When PVDF or a derivative thereof is used as the binder, the adhesive strength of the positive electrode mixture layers 10B to the positive electrode current collector 10A can be ensured, so that it is possible to improve the cycle characteristics and the discharge performance of the battery.

The conductive agent may be, for example, graphites such as natural graphite or artificial graphite, carbon blacks such as acetylene black or ketjen black, or conductive fibers such as carbon fiber or metal fiber.

The positive electrode 10 as described above is formed as follows. After a positive electrode mixture slurry containing a positive electrode active material, a binder, and a conductive agent is prepared, the positive electrode mixture slurry is applied to at least one surface of the positive electrode current collector, and then is dried. Thereafter, the positive electrode current collector having the positive electrode active material, and the like provided on the surface thereof is rolled. In this way, a positive electrode original sheet is formed. The positive electrode original sheet is cut to a predetermined width, thereby obtaining the positive electrode 10. Note that, the content of the positive electrode active material, the binder, and the conductive agent in the positive electrode mixture slurry may be set freely. For example, the positive electrode mixture slurry may include 1-6 parts by volume of the binder per 100 parts by volume of the positive electrode active material.

—Porous Insulating Layer 12—

Examples of materials included in the porous insulating layer 12 are listed below.

The porous insulating layer 12 may be microporous thin film, woven fabric, nonwoven fabric, or the like which has high ion permeability, and has both predetermined mechanical strength and insulating properties. The porous insulating layer 12 is preferably made of, for example, polyolefin such as polypropylene or polyethylene. The thickness of the porous insulating layer 12 may be greater than or equal to 10 μm and less than or equal to 300 μm, is preferably greater than or equal to 10 μm and less than or equal to 40 μm, and is more preferably greater than or equal to 10 μm and less than or equal to 25 μm. The porosity of the porous insulating layer 12 may be greater than or equal to 30% and less than or equal to 70%.

—Electrolyte—

Examples of materials for the electrolyte are listed below.

The electrolyte is, for example, a nonaqueous electrolyte, a gel nonaqueous electrolyte, or a solid nonaqueous electrolyte.

The nonaqueous electrolyte is obtained by dissolving an electrolyte such as lithium salt in a nonaqueous solvent. The electrolyte is, for example, LiClO₄, LiBF₄, or LiPF₆. The nonaqueous solvent is cyclic carbonic ester such as propylene carbonate (PC), chain carbonic ester such as diethyl carbonate (DEC), cyclic carboxylate ester such as γ-butyrolactone (GBL), or the like. The amount of the electrolyte dissolved in the nonaqueous solvent is preferably greater than or equal to 0.5 mol/m³ and less than or equal to 2 mol/m³.

The gel nonaqueous electrolyte is a nonaqueous electrolyte held by a polymer material. The polymer material is, for example, polyvinylidene fluoride or polyacrylonitrile.

The solid nonaqueous electrolyte includes a solid polymer electrolyte.

The present embodiment may have a configuration described below.

Both ends in the width direction of the porous insulating layer are inclined relative to the thickness direction of the porous insulating layer in FIG. 6, but may extend vertically relative to the thickness direction of the porous insulating layer. However, in many cases, the porous insulating layer is adhered to a surface of the negative electrode. For this reason, in many cases, both of the ends in the width direction of the porous insulating layer are inclined relative to the thickness direction of the porous insulating layer.

The negative electrode current collector may be nickel foil. The negative electrode current collector may have a plurality of pores formed therein. The negative electrode original sheet may be cut by the Goebel method or the gang method. These conditions apply to the first and second variations below.

When a silicon compound is used as the negative electrode active material, the silicon compound may be SiOₓ (where 0.05<x<1.95); a silicon alloy in which part of Si is substituted with at least one element selected from the group consisting of B, Mg, Ni, Ti, Mo, Co, Ca, Cr, Cu, Fe, Mn, Nb, Ta, V, W, Zn, C, N and Sn; or a silicon solid solution. When a tin compound is used as the negative electrode active material, the tin compound is Ni₂Sn₄, Mg₂Sn, SnOₓ (where 0<x<2), SnO₂, SnSiO₃, or the like. One of these negative electrode active materials may be used solely, or two or more of them may be used in combination.

The negative electrode may be, as described in the first variation below, formed by densely providing, for example, graphite on surfaces of a negative electrode current collector.

The electrode group may be, as described in the second variation below, formed by stacking a positive electrode and a negative electrode with a porous insulating layer interposed therebetween.

(First Variation)

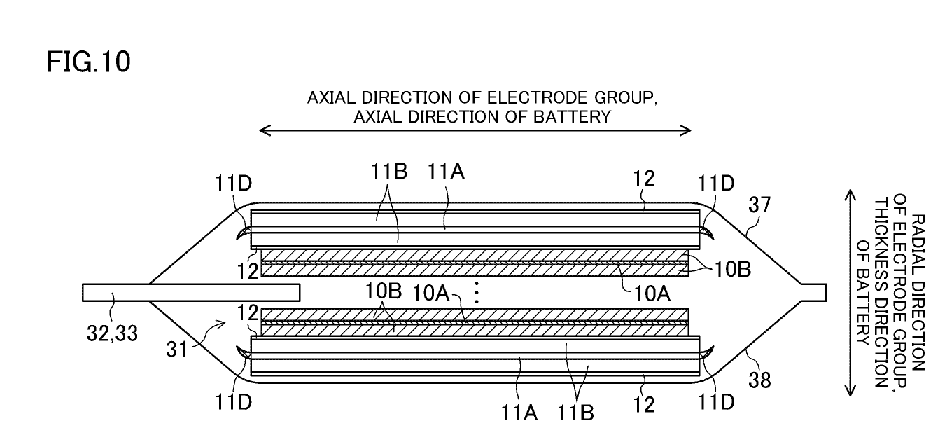

A first variation has the same configuration as that of the first embodiment except for the material of the negative electrode active material. The point different from the first embodiment will mainly be described below. FIG. 10 is a sectional view of a nonaqueous electrolyte secondary battery according to the present variation.

A negative electrode 11 of the present variation includes a negative electrode current collector 11A and negative electrode active material layers 11B. The negative electrode active material layers 11B are provided on surfaces of the negative electrode current collector 11A, and contain a negative electrode active material (e.g., graphite), and a binder. The amount of the negative electrode active material and the binder contained in each negative electrode active material layer 11B may be set accordingly. However, for example, each negative electrode active material layer 11B preferably contains less than or equal to 3 parts by weight of the binder per 100 parts by weight of graphite. The density of the negative electrode active material layer 11B is greater than or equal to 1.50 g/cc and less than or equal to 1.90 g/cc in a discharged state, and is more preferably greater than or equal to 1.60 g/cc and less than or equal to 1.75 g/cc in a discharged state. When the density of the negative electrode active material layer 11B is less than the lower limit of the range mentioned above, the negative electrode active material layer has a large number of voids, which may reduce the battery capacity. In contrast, when the density of the negative electrode active material layer 11B is greater than the upper limit of the range mentioned above, the electrolyte is less likely to penetrate into the negative electrode active material, and the like, which may retard electrode reaction. As described above, in the present embodiment, it is possible to increase the capacity as in the first embodiment. Note that the thickness of the negative electrode current collector 11A is greater than or equal to 20 μm and less than or equal to 50 μm. The thickness of each negative electrode active material layer 11B is 150 μm-200 μm.

The negative electrode 11 of the present variation is formed by cutting a negative electrode original sheet 111 illustrated in FIG. 3A to a predetermined width, and thus ends (cut ends 11b) in the width direction of the negative electrode 11 have cutting roll over portions 11D. The cutting roll over portions 11D are formed by stretching the negative electrode current collector 11A upwardly or downwardly in the thickness direction from cut end faces 11a. For this reason, in the thickness direction of the negative electrode current collector 11A, tips of the cutting roll over portions 11D are located above or below a center portion in the width direction of the negative electrode current collector 11A. The length L₃ of the cutting roll over portions 11D is greater than or equal to 30 μm, and the larger the thickness of the negative electrode current collector 11A is, the larger the length L₃ is. As illustrated in FIG. 10, the cutting roll over portions 11D as described above are oriented toward the inner side in the radial direction of an electrode group 31, and extend along an inner circumferential surface of a battery case. With reference to FIGS. 3A and 3B, a method for forming the electrode group 31 of the present variation will be described below in order to further describe the cutting roll over portions 11D of the present variation.

First, copper foil having a thickness of greater than or equal to 20 μm and less than or equal to 50 μm is prepared as a negative electrode current collector 111A. Moreover, negative electrode mixture paste containing a negative electrode active material (carbon material) and a binder is prepared. After that, the negative electrode mixture paste is applied on both surfaces of the negative electrode current collector 111A, and then is dried. Thereafter, the negative electrode current collector having the negative electrode active material adhered on the surfaces thereof is rolled. In this way, a negative electrode original sheet 111 illustrated in FIG. 3A is obtained.

Next, as illustrated in FIG. 3B, the negative electrode original sheet 111 is cut to a predetermined width.

When the negative electrode original sheet 111 is cut, cutting roll over portions 11D are formed at cut ends 11b. As described in the first embodiment, when attention is directed toward each of negative electrodes 11, the cutting roll over portions 11D are oriented in the same direction in the thickness direction of the negative electrode 11. When attention is directed toward the cut ends 11b adjacent to each other, the cutting roll over portions 11D are oriented in opposite directions in the thickness direction of the negative electrodes 11.

Porous insulating layers 12 are disposed on both surfaces of the thus formed negative electrode 11. Then, a positive electrode 10 is provided on the same side as the cutting roll over portions 11D relative to the negative electrode 11, and the positive electrode 10, the negative electrode 11, and the porous insulating layers 12 are wound so that the negative electrode 11 is located radially outside the positive electrode 10. In this way, the electrode group 31 of the present variation can be obtained. When a nonaqueous electrolyte secondary battery is formed using the electrode group 31, it is possible to reduce internal short-circuits during charge as described in the first embodiment. Thus, the present variation can provide the advantages which are obtainable in the first embodiment.

Note that the negative electrode active material of the present variation may be, for example, various types of natural graphites, coke, partially-graphitized carbon, carbon fiber, spherical carbon, various types of artificial graphites, or amorphous carbon.

(Second Variation)

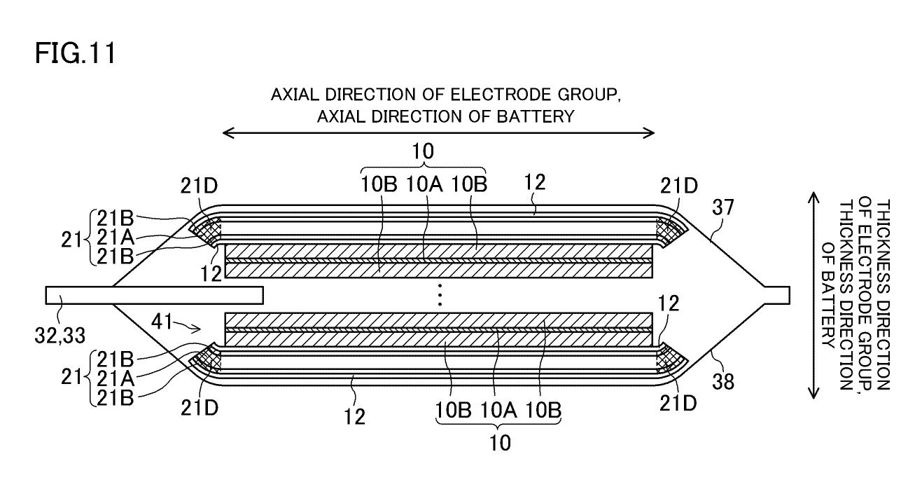

A second variation has the same configuration as that of the first embodiment except for the structure of the electrode group. FIG. 11 is a sectional view of a nonaqueous electrolyte secondary battery according to the present variation.

An electrode group 41 of the present variation includes positive electrodes 10 and negative electrodes 21 which are stacked on one another with porous insulating layers 12 interposed therebetween. Cutting roll over portions 21D exist at both ends in the width direction of each of the negative electrodes 21. The negative electrodes 21 are disposed so that the cutting roll over portions 21D are oriented toward the inner side in the thickness direction of the electrode group 41. Thus, the present variation can provide the advantages which are obtainable in the first embodiment.

Note that the electrode group 41 of the present variation may be formed using the negative electrodes 11 of the first variation. It is possible, also in this case, to provide the advantages which are obtainable in the first embodiment.

### Other Embodiments

The first embodiment, the first variation, and the second variation may have configurations described below.

The configuration of the cutting roll over portions depends on not only materials for the negative electrode active material, but also cutting conditions of the negative electrode original sheet. Therefore, the cutting roll over portions of the first embodiment may be made of only the negative electrode current collector, or the cutting roll over portions of the first variation may be made of the negative electrode current collector and the negative electrode mixture layer. However, regardless of the configuration of the cutting roll over portions, the cutting roll over portions at both ends in the width direction of each negative electrode are oriented in the same direction, and the cutting roll over portions at cut ends adjacent to each other are oriented in opposite directions. Thus, when an electrode group is formed so that the cutting roll over portions are oriented toward the inner side in the radial direction, or when an electrode group is formed so that the cutting roll over portions are oriented toward the inner side in the thickness direction of the electrode group, it is possible to provide the advantages which are obtainable in the first embodiment.

The shapes of the cutting roll over portions are not limited to those illustrated in FIGS. 2-4 and FIGS. 6-11.

The battery case may be made of metal. However, the battery case is preferably made of laminate film such as aluminum laminate film or stainless laminate film. When the battery case is made of laminate film, the electrode group is sandwiched between two sheets of the laminate film, and then, an electrolyte is poured, and thereafter, the two sheets of the laminate film are welded to each other by evacuation. Here, the cutting roll over portions are oriented toward the inner side in the radial direction of the electrode group, and thus the laminate film lies along the cutting roll over portions. Thus, the battery case can be prevented from being broken by the cutting roll over portions during the evacuation, so that deterioration in manufacturing yield can be limited to a lesser extent. Moreover, bending of the cutting roll over portions during the evacuation can be prevented, so that it is possible to prevent a bent cutting roll over portion from coming into contact with a counter electrode (positive electrode). Thus, it is possible to prevent the occurrence of an internal short-circuit.

When the battery case is made of laminate film, a positive electrode lead and a negative electrode lead are preferably welded at an innermost circumference portion of the electrode group of each current collector. In this way, it is possible to increase the reliability of welding of laminate. Note that a method for exposing a portion of each current collector to which the lead will be connected may be a method in which the portion of the current collector to which the lead will be connected is not provided with silicon, tin, a compound of silicon or tin, or mixture paste (a method using a die coater), or a method in which silicon, tin, a compound of silicon or tin, or mixture paste is provided on entire surface of the current collector, and then the silicon, or the like on the relevant portion is removed.

The width of the negative electrode may be the same as that of the positive electrode. However, when the width of the negative electrode is larger than that of the positive electrode, it is possible to prevent a reduction in the battery capacity and internal short-circuits. Thus, the width of the negative electrode is preferably larger than that of the positive electrode.

The above nonaqueous electrolyte secondary batteries are, of course, not limited to the square batteries. The nonaqueous electrolyte secondary batteries may be cylindrical batteries.

### EXAMPLES

Examples of the present invention will be described below.

### First Example

In a first example, Batteries 1-5 were fabricated, and initial discharge capacities were measured, and it was examined whether or not a short-circuit occurred.

1. Method of Experiment

—Method for Fabricating Battery—

A method for fabricating Battery 1 will be described in detail below.

(Battery 1)

(Formation of Positive Electrode)

First, LiNi_{0.82}Co_{0.15}Al_{0.03}O₂ (positive electrode active material) having an average particle size of 10 μm was prepared.

Next, LiNi_{0.82}Co_{0.15}Al_{0.03}O₂, acetylene black (conductive agent), and a solution obtained by dissolving polyvinylidene fluoride (PVDF, binder) in N-methyl pyrrolidone (NMP) were mixed, thereby obtaining a positive electrode mixture slurry. Here, LiNi_{0.82}Co_{0.15}Al_{0.03}O₂, acetylene black, and polyvinylidene fluoride were prepared at a volume ratio of 100:4.5:4.7.

Subsequently, the positive electrode mixture slurry was applied both surfaces of aluminum foil (positive electrode current collector) having a thickness of 15 μm, and then was dried. Thereafter, the positive electrode current collector with the positive electrode active material, the conductive agent, and the binder provided on the surfaces thereof was rolled, thereby obtaining a positive electrode original sheet having a thickness of 0.185 mm. The positive electrode original sheet was cut to a width of 57 mm and a length of 454 mm, thereby obtaining positive electrodes each having a thickness of 0.185 mm, a width of 57 mm, and a length of 454 mm.

In the present example, the positive electrode original sheet was cut using a Goebel slitter. Cut surfaces of the positive electrodes were observed. No roll over portion was formed at the cut surfaces, and the cut surfaces extended substantially parallel to the thickness direction of the positive electrodes.

(Formation of Negative Electrode)

First, flake artificial graphite was pulverized and classified to obtain artificial graphite having an average particle size of about 20 μm as a negative electrode active material.

Next, 3 parts by mass of styrene-butadiene-rubber (binder) and 100 parts by mass of an aqueous solution containing 1 parts by mass of carboxymethylcellulose were added to 100 parts by mass of the negative electrode active material, thereby obtaining a negative electrode mixture slurry.

Subsequently, the negative electrode mixture slurry was applied to both surfaces of copper foil (negative electrode current collector) having a thickness of 20 μm, and then was dried. Thereafter, the negative electrode current collector with the negative electrode active material and the binder provided on both the surfaces thereof was rolled, thereby obtaining a negative electrode original sheet having a thickness of 0.230 mm. The negative electrode original sheet was subjected to hot air in a nitrogen atmosphere at 190° C. for 8 hours to perform a thermal treatment on the negative electrode original sheet. After that, the negative electrode original sheet was cut to a width of 58.5 mm and a length of 583 mm, thereby obtaining negative electrodes each having a thickness of 0.230 mm, a width of 58.5 mm, and a length of 583 mm.

In the present example, the negative electrode original sheet was cut using a Goebel slitter. Cut surfaces of the negative electrodes were observed. Cutting roll over portions illustrated in FIG. 4B were formed at cut ends. Moreover, the cutting roll over portions were oriented in the same direction at both ends in the width direction of each negative electrode.

(Preparation of Nonaqueous Electrolyte)

Ethylene carbonate and dimethyl carbonate were mixed at a volume ratio of 1:3, thereby obtaining a mixed solvent (nonaqueous solvent). To the mixed solvent, 5 wt. % of vinylene carbonate (an additive to increase the charge/discharge efficiency of the battery) was added, and LiPF₆ (electrolyte) was further dissolved in the nonaqueous solvent at a mole concentration of 1.4 mol/dm³. In this way, a nonaqueous electrolyte was obtained.

(Fabrication of Square Aluminum Laminate Battery)

First, a positive electrode lead (6 mm in width) made of aluminum was connected to the positive electrode current collector by ultrasonic bonding, and a negative electrode lead (4 mm in width) made of nickel was connected to the negative electrode current collector by resistance welding. Here, the leads were connected to portions located at an innermost circumference of the electrode group when wound. Then, the positive electrode lead was protected and insulated using an adhesive tape having a width of 8 mm and made of polypropylene, and the negative electrode lead was protected and insulated using an adhesive tape made of polyethylene.

Next, the positive electrode and the negative electrode were arranged so that tips of the cutting roll over portions were disposed on the positive electrode side. A separator made of polyethylene was disposed between the positive electrode and the negative electrode. After that, the positive electrode, the negative electrode, and the separator were wound so that the negative electrode was located radially outside the positive electrode. Then, heat-welding tape made of polypropylene was provided on portions of the positive electrode lead and the negative electrode lead which are in contact with aluminum laminate film.

Subsequently, two sheet of aluminum laminate film were stacked on one another and welded to each other at three of four sides of each sheet of aluminum laminate film. The electrode group was placed in the bag-like battery case with only one side open. Thereafter, the nonaqueous electrolyte was injected into the battery case by a decompression process. Then, the opening of the battery case was heat-welded while decompressing, thereby fabricating a battery. This battery is referred to as Battery 1.

(Battery 2)

Except that the electrode group was formed by arranging the negative electrode such that the cutting roll over portions of the negative electrode were oriented toward the outer side in the radial direction of the electrode group, Battery 2 was fabricated in the same manner as Battery 1.

(Battery 3)

Except that the width of the negative electrode was changed from 58.5 mm to 57.0 mm (the width of the negative electrode was the same as that of the positive electrode), Battery 3 was fabricated in the same manner as Battery 1.

(Battery 4)

Except that the width of the negative electrode was changed from 58.5 mm to 57.0 mm, Battery 4 was fabricated in the same manner as Battery 2.

(Battery 5)

Except that the negative electrode original sheet was cut using a gang slitter, Battery 5 was fabricated in the same manner as Battery 1. Note that when cut surfaces of the negative electrode of Battery 5 were observed, cutting roll over portions illustrated in FIG. 3B were formed at cut ends. Moreover, the cutting roll over portions were oriented in the same direction at both ends in the width direction of each negative electrode.

The initial discharge capacities of thus fabricated Batteries 1-5 were measured, and it was examined whether or not a short-circuit occurred.

—Method for Measuring Initial Discharge Capacity—

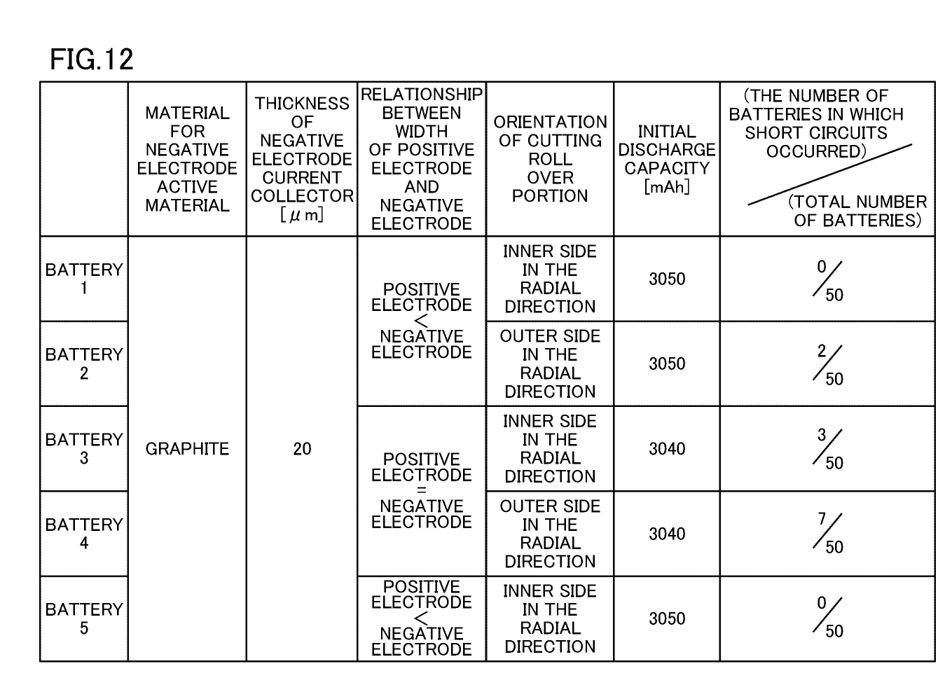

Batteries 1-5 were charged with a constant current of 1.4 A until a voltage reached 4.2 V in an environment of 25° C., and were charged with a constant voltage of 4.2 V until a current value reached 50 mA. Then, Batteries 1-5 were discharged with a constant current of 0.56 A until the voltage reached 2.5 V. Thereafter, the capacities were measured. Results are shown in FIG. 12.

—Method for Examining Whether or Not Short-circuit Occurred—

A cycle test and a storage test described below were sequentially performed, and then whether or not a short-circuit occurred was examined.

(Cycle Test)

Batteries 1-5 were charged with a constant current of 1.4 A in an environment of 45° C. until a voltage reached 4.2 V, and were charged with a constant voltage of 4.2 V until a current reached 50 mA. Then, Batteries 1-5 were discharged at a constant current of 2.8 A until the voltage reached 2.5 V. A series of the operation was repeated 20 times.

(Storage Test)

Batteries after the cycle test were charged with a constant current of 1.4 A in an environment of 45° C. until a voltage reached 4.2 V, and were charged with a constant voltage of 4.2 V until a current reached 50 mA. Then, the batteries were stored in an environment of 60° C. for 2 weeks.

Thereafter, the voltages of the batteries were measured, and it was examined whether or not the measured voltages were less than 4.10 V. Then, it was concluded that a short-circuit occurred in the batteries in which the measured voltages were less than 4.10 V, and the number of such batteries was counted. Results are shown in FIG. 12.

### Second Example

In a second example, Batteries 6-9 were fabricated, and the initial discharge capacities thereof were measured, and it was examined whether or not a short-circuit occurred. In the second example, silicon was used as the negative electrode active material. For this reason, the size of a positive electrode and a method for fabricating a negative electrode of the second example are different from those of the first example. Points which are different from those of the first example will be described.

(Battery 6)

(Formation of Positive Electrode)

A positive electrode was formed in the same manner as Battery 1. Note that the positive electrode had a thickness of 0.185 mm, a width of 57 mm, and a length of 293 mm.

(Formation of Negative Electrode)

First, copper foil (38 μm in thickness) both surfaces of which were roughened by electrolytic plating was prepared as the negative electrode current collector.

Next, silicon (99.8% purity) was placed in a graphite crucible in a vacuum chamber, and the negative electrode current collector was disposed directly above the graphite crucible. After that, the silicon in the graphite crucible was melted and evaporated by an electron beam. In this way, the silicon was evaporated on surfaces of the negative electrode current collector. The silicon was evaporated until the thickness of a silicon film on each of the surfaces of the negative electrode current collector became 8 μm. In this way, a negative electrode original sheet was formed.

Then, the negative electrode original sheet was cut to a width of 58.5 mm, and a length of 380 mm. In this way, negative electrodes each having a thickness of 0.054 mm, a width of 58.5 mm, and a length of 380 mm were obtained.

In the present example, the negative electrode original sheet was cut using a Goebel slitter. When cut surfaces were observed, cutting roll over portions illustrated in FIG. 4B were formed at cut ends. Moreover, the cutting roll over portions were extended in the same direction at both ends in the width direction of each negative electrode.

(Battery 7)

Except that the electrode group was formed so that the negative electrode was arranged with its cutting roll over portions being oriented toward the outer side in the radial direction of the electrode group, Battery 7 was fabricated in the same manner as Battery 6.

(Battery 8)

Except that the width of the negative electrode was changed from 58.5 mm to 57.0 mm (the width of the negative electrode was the same as that of the positive electrode), Battery 8 was fabricated in the same manner as Battery 6.

(Battery 9)

Except that the width of the negative electrode was changed from 58.5 mm to 57.0 mm, Battery 9 was fabricated in the same manner as Battery 7.

The initial discharge capacities of Batteries 6-9 fabricated in this way were measured, and it was examined whether or not a short-circuit occurred. A method for measuring the initial discharge capacities and a method for examining whether or not a short-circuit occurred are as described in the first example.

2. Discussion

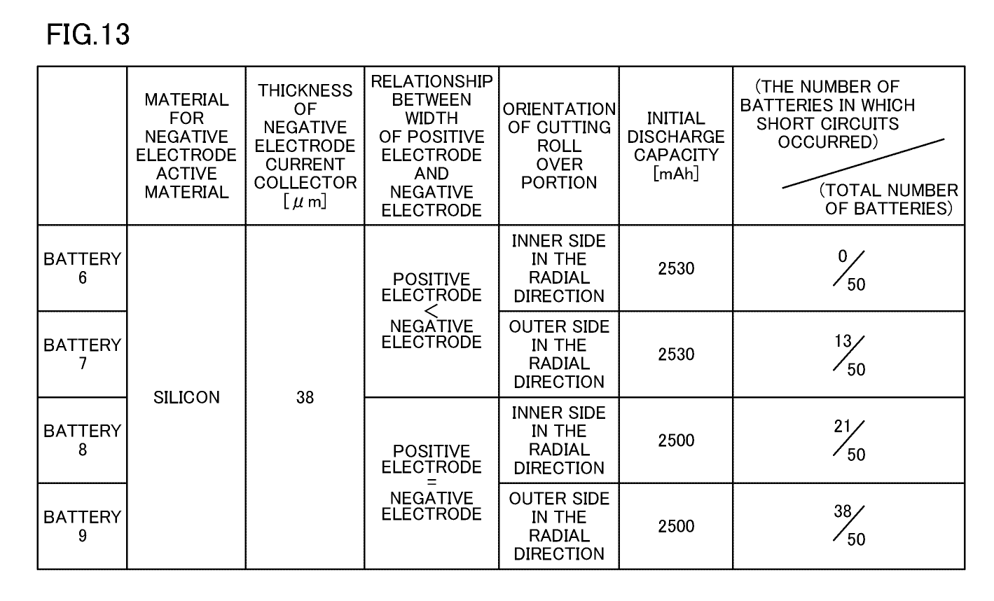

Results of the first example are shown in FIG. 12, and results of the second example are shown in FIG. 13.

First, the initial discharge capacities are discussed.

In the first example, the initial discharge capacity was smaller in Batteries 3 and 4 than in Batteries 1, 2, and 5. In the second example, the initial discharge capacity was smaller in Batteries 8 and 9 than in Batteries 6 and 7. This is probably because each of Batteries 3, 4, 8, and 9 has the positive electrode and the negative electrode whose widths are the same. That is, when the width of the positive electrode and the width of the negative electrode are the same, the electrode group in which the positive electrode and the negative electrode are shifted relative to each other in the width direction may be formed. Therefore, the formed electrode group has a portion where the positive electrode and the negative electrode do not face each other. In the portion where the positive electrode and the negative electrode do not face each other, insertion/extraction of lithium is less likely to occur between the positive electrode active material and the negative electrode active material, which reduces the initial discharge capacity (reduces the battery capacity).

Next, whether or not a short-circuit occurred is discussed.

Short-circuits occurred in two batteries of Battery 2 of the first example. The batteries in which short-circuits occurred were disassembled for analysis, and the followings were found. The electrode group of each of the batteries was deformed due to deformation of the negative electrode, and at portions where the electrode group was significantly deformed, the negative electrode pushed the separator away, and was in contact with the positive electrode. This is probably because the cutting roll over portions of Battery 2 are oriented toward the outer side in the radial direction of the electrode group.

The number of batteries in which short-circuits occurred was larger in Batteries 3 and 4 than in Battery 2 of the first example. Batteries of Batteries 3 and 4 in which short-circuits occurred were disassembled, and the followings were found. The separator was broken by the cutting roll over portions penetrating therethrough, and the cutting roll over portions were in contact with the positive electrode. This is probably because of the shift at the time of winding described above (the shift is that the electrode group is formed with its positive electrode and negative electrode being shifted relative to each other).

Although Battery 1 and Battery 5 were different from each other in shape and configuration of the cutting roll over portions, it was possible to reduce short-circuits in Batteries 1 and 5.

The negative electrode active material of the second example is capable of inserting more lithium ions compared to the negative electrode active material of the first example. Therefore, the stress caused by the expansion of the negative electrode active material is larger than that of the first example. Even in this case, it was possible to reduce short-circuits when the cutting roll over portions were oriented toward the inner side in the radial direction of the electrode group as in Battery 6.

### INDUSTRIAL APPLICABILITY

As described above, the present invention is applicable to, for example, power supplies for consumer electronics, power supplies for use in vehicles, power supplies for large-size tools, etc. which have an increased energy density.

### DESCRIPTION OF REFERENCE CHARACTERS

10 Positive Electrode
11, 21 Negative Electrode
11A, 21A, 111A, 121A Negative Electrode Current Collector
11B, 21B, 111B, 121B Negative Electrode Active Material Layer
11D, 21D Cutting Roll Over
11A, 21A Cut End Face
11B, 21B Cut End
12 Porous Insulating Layer
111, 121 Negative Electrode Original Sheet

1. A nonaqueous electrolyte secondary battery comprising:
an electrode group including a positive electrode, a negative electrode, and a porous insulating layer provided between the positive electrode and the negative electrode, wherein
the negative electrode includes a negative electrode current collector having a thickness of greater than or equal to 20 μm and less than or equal to 50 μm, and a negative electrode active material layer provided on at least one surface of the negative electrode current collector, the negative electrode active material layer containing a negative electrode active material,
the negative electrode is formed by cutting a negative electrode original sheet to a predetermined width,
the negative electrode has a cutting roll over portion at a cut end thereof, and
the cutting roll over portion is formed by stretching the negative electrode current collector upwardly or downwardly in a thickness direction of the negative electrode, the cutting roll over portion being oriented toward an inner side of the electrode group.

2. The nonaqueous electrolyte secondary battery of claim 1, wherein
the positive electrode and the negative electrode of the electrode group are wound with the porous insulating layer interposed therebetween, and
the cutting roll over portion is oriented toward an inner side in a radial direction of the electrode group.

3. The nonaqueous electrolyte secondary battery of claim 1, wherein
the positive electrode and the negative electrode of the electrode group are stacked with the porous insulating layer interposed therebetween, and
the cutting roll over portion is oriented toward an inner side in a thickness direction of the electrode group.

4. The nonaqueous electrolyte secondary battery of claim 1, wherein
a width of the negative electrode is larger than that of the positive electrode.

5. The nonaqueous electrolyte secondary battery of claim 1, wherein
the negative electrode active material is silicon, tin, a silicon compound, or a tin compound.

6. The nonaqueous electrolyte secondary battery of claim 1, wherein
the cutting roll over portion is formed by stretching the negative electrode current collector and the negative electrode active material layer.

7. A method for fabricating a nonaqueous electrolyte secondary battery having an electrode group including a positive electrode, a negative electrode, and a porous insulating layer provided between the positive electrode and the negative electrode, the method comprising:
(a) preparing a negative electrode original sheet including a negative electrode current collector and a negative electrode active material layer provided on at lest one surface of the negative electrode current collector, the negative electrode active material layer containing a negative electrode active material;
(b) cutting the negative electrode original sheet to a predetermined width to form a plurality of negative electrodes; and
(c) disposing the porous insulating layer between the positive electrode and one of the negative electrodes formed in (b) to form the electrode group, wherein
a thickness of the negative electrode current collector is greater than or equal to 20 μm and less than or equal to 50 μm,
in (b), cutting roll over portions are formed at cut ends of each of the negative electrodes by stretching the negative electrode current collector upwardly or downwardly in a thickness direction of the negative electrodes, and the cutting roll over portions at both the ends in the width direction of each negative electrode are oriented in a same direction, whereas the cutting roll over portions at the cut ends adjacent to each other are oriented in opposite directions, and
in (c), the electrode group is formed such that the cutting roll over portions are oriented toward an inner side of the electrode group.

8. The method of claim 7, wherein
in (c), the positive electrode and the negative electrode are wound with the porous insulating layer interposed therebetween such that the cutting roll over portions are oriented toward an inner side in a radial direction of the electrode group.
